(19) United States
(12) Patent Application Publication
(10) Pub. No.: US 2022/0267600 A1
(43) Pub. Date: Aug. 25, 2022

(54) Blowing Agent Composition of Hydrochlorofluoroolefin

(71) Applicant: Arkema Inc., King of Prussia, PA (US)

(72) Inventors: Benjamin Bin Chen, King of Prussia, PA (US); Joseph S. Costa, King of Prussia, PA (US)

(21) Appl. No.: 17/723,521

(22) Filed: Apr. 25, 2022

Related U.S. Application Data
(63) Continuation-in-part of application No. 15/680,738, filed on Aug. 18, 2017, now abandoned.
Application No. 15/680,738 is a continuation-in-part of application No. 14/992,250, filed on Jan. 11, 2016, now Pat. No. 9,738,768.
Application No. 14/992,250 is a continuation-in-part of application No. 13/649,346, filed on Oct. 11, 2012, now Pat. No. 9,234,070.
Application No. 13/649,346 is a continuation-in-part of application No. 12/532,183, filed on Sep. 21, 2009, now Pat. No. 8,314,159.
(60) Provisional application No. 60/972,037, filed on Sep. 13, 2007.
(60) Provisional application No. 60/949,656, filed on Jul. 13, 2007.
(60) Provisional application No. 60/908,751, filed on Mar. 29, 2007.

(51) Int. Cl. C08L 79/00; C08J 9/14

(52) U.S. Cl. CPC C08L 79/00; C08J 2427/12; C08J 2379/00; C08J 9/149

(57) ABSTRACT

A blowing agent for thermosetting foams is disclosed. The blowing agent is predominately the trans isomer of the hydrochlorofluoroolefin (HCFO) HFCO-1233zd alone or in combination with a hydrofluoroolefin (HFO), hydrofluorocarbon (HFC), hydrochlorofluoroolefin (HCFO), a hydrocarbon. The blowing agent is effective as a blowing agent in the manufacture of thermosetting foams.

This application is continuation-in-part of U.S. patent application Ser. No. 15/680,738 filed Aug. 18, 2017 which is a continuation-in-part of U.S. patent application Ser. No. 14/992,250 filed Jan. 11, 2016 which is a continuation-in-part of U.S. patent application Ser. No. 13/649,346, filed Oct. 11, 2012, which is a continuation-in-part of U.S. patent application Ser. No. 12/532,183, filed Sep. 21, 2009, which claims priority to International patent application serial number PCT/US2008/058600, filed Mar. 28, 2008, which claims priority to U.S. provisional patent application Ser. No. 60/972,037, filed Sep. 13, 2007, and United Stated provisional patent application Ser. No. 60/949,656, filed Jul. 13, 2007 and U.S. provisional application Ser. No. 60/908,751, filed Mar. 29, 2007.

### FIELD OF THE INVENTION

The present invention relates to blowing agents for thermosetting foams. More particularly, the present invention relates to the use of the hydrochlorofluoroolefin (HCFO) HCFO-1233zd alone or in a combination as a blowing agent in the manufacture of thermosetting foams. The HCFO-1233zd of the present invention is predominantly the trans isomer.

### BACKGROUND OF THE INVENTION

The Montreal Protocol for the protection of the ozone layer, signed in October 1987, mandated the phase out of the use of chlorofluorocarbons (CFCs). Materials more “friendly” to the ozone layer, such as hydrofluorocarbons (HFCs) eg HFC-134a replaced chlorofluorocarbons. The latter compounds have proven to be green house gases, causing global warming and were regulated by the Kyoto Protocol on Climate Change, signed in 1998. The emerging replacement materials, hydrofluoropropenes, were shown to be environmentally acceptable i.e. has zero ozone depletion potential (ODP) and acceptable low global warming potential (GWP).

Currently used blowing agents for thermoset foams include HFC-134a, HFC-245fa, HFC-365mfc that have relatively high global warming potential, and hydrocarbons such as pentane isomers which are flammable and have low energy efficiency. Therefore, new alternative blowing agents are being sought. Halogenated hydroolefinic materials such as hydrofluoropropenes and/or hydrochlorofluoropropenes have generated interest as replacements for HFCs. The inherent chemical instability of these materials in the lower atmosphere provides the low global warming potential and zero or near zero ozone depletion properties desired.

The object of the present invention is to provide novel compositions that can serve as blowing agents for thermosetting foams that provide unique characteristics to meet the demands of low or zero ozone depletion potential, lower global warming potential and exhibit low toxicity.

### BRIEF DESCRIPTION OF THE DRAWINGS

FIG. 1 is a graph of initial k-factor versus temperature from Example 2.

FIG. 2 is a graph of k-factor at one week versus temperature from Example 2.

FIG. 3 is a graph of k-factor at one month versus temperature from Example 2.

FIG. 4 is a graph of k-factor at three months versus temperature from Example 5.

FIG. 5 is a graph of k-factor at six months versus temperature from Example 5.

FIG. 6 is a graph of percent change in k-factor in Btu·in./ft²·h·° F. at 50° F. (10° C.) mean test from Example 5.

### DETAILED DESCRIPTION OF THE INVENTION

The present invention relates to the use of blowing agents with negligible (low or zero) ozone-depletion and low GWP based upon unsaturated halogenated hydroolefins. The blowing agents comprise the hydrochlorofluoroolefin (HCFO), 1-chloro-3,3,3-trifluoropropene (HCFO-1233zd) alone or in a combination including a hydrofluoroolefin (HFO), a hydrochlorofluoroolefin (HCFO), a hydrofluorocarbon (HFC), a hydrocarbon, an alcohol, an aldehyde, a ketone, an ether/diether or carbon dioxide. The HCFO-1233zd of the present invention is predominantly the trans isomer of HCFO-1233zd.

Trans (E) and cis (Z) isomers are illustrated:

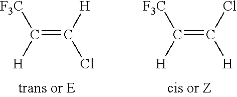 [SMILES: FC(F)(F)/C=C/Cl ; FC(F)(F)/C=C\Cl]

Hydrochlorofluoroolefin (HCFO) HCFO-1233 has been proposed as blowing agents which exhibit a low global warming potential and a low ozone depletion value. The low global warming potential and a low ozone depletion value are a result of the atmospheric degradation of the hydrohaloolefins.

The predominately trans isomer of the hydrochlorofluoroolefin HCFO-1233zd, alone or in a combination with HFOs can be used as a foaming agent for thermosetting foams by being mixed in a polyols mixture. The resulted products show superior quality including decreased density and improved k-factor. The foaming agent readily dissolves in thermosetting polymers, and provides a degree of plasticization sufficient to produce acceptable foams. HCFO 1233zd is a liquid at ambient temperature, which allows for ease of handling as is desired by various industries particularly for polyurethane foams. The preferred HFO component typically contains 3 or 4 carbons, and including but not limited to pentafluoropropene, such as 1,2,3,3,3-pentafluoropropene (HFO 1225ye), tetrafluoropropene, such as 1,3,3,3-tetrafluoropropene (HFO 1234ze), 2,3,3,3-tetrafluoropropene (HFO 1234yf), 1,2,3,3-tetrafluoropropene (HFO1234ye), trifluoropropene, such as 3,3,3-trifluoropropene (1243zf). Preferred embodiments of the invention are blowing agent compositions of unsaturated halogenated hydroolefins with normal boiling points less than about 60° C.

The preferred blowing agent composition, either HCFO-1233zd, predominately the trans isomer, alone or in a combination, of the present invention exhibits good solubility in polyol mixture used in producing polyurethane and polyisocyanurate foams. A major portion of the HCFO-1233zd component of the present invention is the trans isomer. It was discovered that the trans isomer exhibits a significantly lower genotoxicity in AMES testing than the cis isomer. A preferred ratio of trans and cis isomers of HCFO-1233zd is less than about 30% weight of the combination of the cis isomer, and preferably less than about 10% of the cis isomer. The most preferred ratio is less than about 3% of the cis isomer. The preferred blowing agent combination produces foam having desirable levels of insulating value.

The HCFO-1233zd of the present invention may be used in combination with other blowing agents including but not limited to: (a) hydrofluorocarbons including but not limited to difluoromethane (HFC32); 1,1,1,2,2-pentafluoroethane (HFC125); 1,1,1-trifluoroethane (HFC143a); 1,1,2,2-tetrafluorothane (HFC134); 1,1,1,2-tetrafluoroethane (HFC134a); 1,1-difluoroethane (HFC152a); 1,1,1,2,3,3,3-heptafluoropropane (HFC227ea); 1,1,1,3,3-pentafluoropropane (HFC245fa); 1,1,1,3,3-pentafluorobutane (HFC365mfc) and 1,1,1,2,2,3,4,5,5,5-decafluoropentane (HFC4310mee). (b) hydrofluoroolefins including but not limited to tetrafluoropropenes (HFO1234), trifluoropropenes (HFO1243), all tetrafluorobutene isomers (HFO1354), all pentafluorobutene isomers (HFO1345), all hexafluorobutene isomers (HFO1336), all heptafluorobutene isomers (HFO1327), all heptafluoropentene isomers (HFO1447), all octafluoropentene isomers (HFO1438), all nonafluoropentene isomers (HFO1429), (c) hydrocarbons including but not limited to, pentane isomers, butane isomers, (d) C1 to C5 alcohols, C1 to C4 aldehydes, C1 to C4 ketones, C1 to C4 ethers and diethers and carbon dioxide, (e) HCFOs such as 2-chloro-3,3,3-trifluoropropene (HCFO-1233xf) and dichlorotrifluoropropene (HCFO1223).

The foamable compositions of the present invention generally include one or more components capable of forming foam having a generally cellular structure and a blowing agent, typically in a combination, in accordance with the present invention. In certain embodiments, the one or more components comprise a thermosetting composition capable of forming foam and/or foamable compositions. Examples of thermosetting compositions include polyurethane and polyisocyanurate (PIR) foam compositions, and also phenolic foam compositions. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure.

Polyisocyanurate foams are typically formed form organic polyisocyanates correspond to the formula: R(NCO)z, wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are employed in amounts which will yield an NCO/OH stoichiometric ratio in a range of from about 0.9 to about 5.0. In the present invention, the NCO/OH equivalent ratio is, preferably, about 1.0 or more and about 3.0 or less, with the ideal range being from about 1.1 to about 2.5. Especially suitable organic polyisocyanate include polymethylene polyphenyl isocyanate, methylene bis(phenyl isocyanate), toluene diisocyanates, or combinations thereof.

The present invention also relates to improvements in both system performance and foam properties that can be obtained by the addition of HFO-1233zd to a pentane blown PIR system. While maintaining the same blowing agent level, replacing some of the pentane blowing agent with increasing amounts of HFO-1233zd, provided improvements in thermal insulation. The pentane blowing agent can be one or more of the isomers of pentane. Preferably, the pentane portion of the blowing agent combination is a blend of normal pentane and isopentane. Additionally, replacing some of the normal pentane and/or isopentane blowing agent with increasing amounts of HFO-1233zd was found to positively impact other properties, such as compressive strength, dimensional stability, and small scale fire performance. Examples 6 and 7 show improvements in the performance of a normal pentane/isopentane boardstock foam achieved by the replacement of from as little as 10% to as much as 60% of the pentane with HCFO-1233zd. Example 6, shows that on average, each increase in HCFO-1233zd showed a better thermal conductivity over the previous lower loading; from a low of 2.6% better, versus the control, for the 10% loading to a high of over 20% better for the all HCFO-1233zd. Additionally, this difference was fairly consistent over 4 months of aging data, especially for blends of ≤60% loading. These improvements were confirmed with the machine runs as was the overall enhancement in the thermal insulation value over the entire test temperature range, especially at the lower temperatures of 0° C. (32° F.) and 10° C. (50° F.).

The invention also relates to foam, and preferably closed cell foam, prepared from a polymer foam formulation containing a blowing agent comprising the compositions of the present invention. In yet other embodiments, the invention provides foamable compositions comprising thermosetting foams, such as polyurethane and polyisocyanurate foams, preferably low-density foams, flexible or rigid.

The invention also relates to foam, and preferably closed cell foam, prepared from a polymer foam formulation containing a blowing agent comprising the compositions of the present invention which exhibits a stable k-factors over time. In yet other embodiments, the invention provides foamable compositions comprising thermosetting foams, such as polyurethane and polyisocyanurate foams, preferably low-density foams, flexible or rigid which exhibit k-factors substantially similar to current commercial blowing agents such as HFC245fa over time.

It will be appreciated by those skilled in the art that the order and manner in which the blowing agent combination of the present invention is formed and/or added to the foamable composition does not generally affect the operability of the present invention. For example, in the case of polyurethane foams, it is possible that the various components of the blowing agent combination, and even the components of the present composition, not be mixed in advance of introduction to the foaming equipment, or even that the components are not added to the same location in the foaming equipment. Thus, in certain embodiments it may be desired to introduce one or more components of the blowing agent combination in a blender with the expectation that the components will come together in the foaming equipment and/or operate more effectively in this manner. Nevertheless, in certain embodiments, two or more components of the blowing agent combination are combined in advance and introduced together into the foamable composition, either directly or as part of premix that is then further added to other parts of the foamable composition.

### EXAMPLES

### Example 1

The formulations tested in Examples 1 to 5 (all had an Iso Index on ROH of 114) each contained Rubinate M, a polymeric methylene diphenyl diisocyanate (MDI) available from Huntsman; Jeffol R-425-X, a polyol from Huntsman; Voranol 490, a polyol from Dow Chemical, Terate 2541, a polyol from Invista. Antiblaze 80 is a flame retardant from Rhodia; Tegostab B 8404 is a surfactant from Goldschmidt Chemical Corporation. Polycat 8 and 5 (pentamethyldiethylenetriamine, PMDETA) are available from Air Products. Total blowing level is 24.5 mls/g. Table 1 summarizes the properties of the formulation tested.

TABLE 1

| Formulation | % (Weight) |
|---|---|
| Jeffol R-425-X | 10.33 |
| Voranol 490 | 17.21 |
| Terate 2541 | 6.88 |
| Antiblaze 80 | 2.29 |
| Water | 0.79 |
| Tegostab B8404 | 0.69 |
| Polycat 8 | 0.36 |
| PMDETA | 0.12 |
| 1233zd | 8.61 |
| Rubinate M | 52.72 |
| Total | 100.00 |

The A-side (MDI) and B-side (mixture of the polyol, surfactant, catalysts, blowing agent, and additives) were mixed with a hand mixer and dispensed into a container to form a free rise foam. When making a free rise foam, the dispensed material was allowed to expand in an open container. The resulting foam had a 26-second gel time, and 41-second tack free time, a free rise density of 1.69 lb(s)/ft³ (lb/ft³). When making a molded foam, the dispensed material was allowed to expand in a closed mold. The mold was kept closed for a few minutes before releasing the foam. The k-factor measurements (ASTM C518) on the resulting foams were conducted at between 10 and 130° F. Initial k-factors are taken within 24 hours after removing foam skin with a band saw. Lower k-factors indicate better insulation values. The results are summarized in Table 2.

TABLE 2

| Temperature | K factor |
|---|---|
| ° F. | Btu · in./ft² · h · ° F. |
| 17.6 | 0.1271 |
| 32.0 | 0.1285 |
| 50.0 | 0.1320 |
| 75.2 | 0.1398 |
| 104.0 | 0.1499 |

### Example 2

In the following examples, the foam was made by small polyurethane dispenser unless otherwise specified. The dispenser consisted of two pressurized cylinders, one for the A side (MDI) and one for the B side (polyol mixtures). The pressure in the cylinders could be adjusted by regulators. B-side mixtures were pre-blended and then charged into pressurized cylinders. Blowing agents were then added into B-side cylinder and mixed thoroughly. The cylinders were connected to a dispensing gun equipped with a static mixer. The pressures of both cylinders were adjusted so that desired ratio of the A and B sides could be achieved. The formulations tested (all had an Iso Index on ROH of 110) each contained Rubinate M, a polymeric methylene diphenyl diisocyanate (MDI) available from Huntsman; Jeffol SG-360 and R-425-X, polyols from Huntsman; TEAP-265, a polyol from Carpenter Company. TegostabB 8465 a surfactant available from Evonik-Degussa. Jeffcat TD33A and ZR-70 are catalysts from Huntsman. NP 9.5, a compatibilizer from Huntsman. Total blowing agent level was 26.0 mls/g. Table 3 summarizes the formulations of the study.

TABLE 3
Formulations

Formulation (wt %)

| | HCFO-1233zd | | |
|---|---|---|---|
| | (trans) | HFO1234ze | HFC134a |
| Jeffol SG-360 | 14.77 | 14.93 | 15.35 |
| Jeffol R-425-X | 4.22 | 4.27 | 4.39 |
| TEAP-265 | 8.44 | 8.53 | 8.77 |
| DEG | 2.11 | 2.13 | 2.19 |
| Jeffcat TD33A | 0.23 | 0.23 | 0.23 |
| Jeffcat ZR70 | 0.23 | 0.23 | 0.23 |
| Tegostab B8465 | 0.90 | 0.89 | 0.90 |
| NP 9.5 | 6.50 | 6.50 | 6.50 |
| Water | 0.42 | 0.42 | 0.42 |
| HFO1234ze | 0 | 11.56 | 0 |
| HCFO-1233zd | 12.11 | 0 | 0 |
| HFC 134a | 0 | 0 | 9.47 |
| Rubinate M | 50.1 | 50.4 | 51.6 |
| A/B | 1.00 | 1.02 | 1.06 |

The k-factor measurements (ASTM C518) on the resulting foams were conducted at between 10 and 130° F. The results are summarized in Table 4. Initial k-factors are taken within 48 hours after removing the foam skin with a band saw. Lower k-factors indicate better insulation values. The results show the k-factor of foam blown with trans HCFO-1233zd is superior to foam blown with HFO1234ze or HFC134a.

TABLE 4
Comparison of k-factor of foams

| Temperature | HCFO-1233zd (trans) | HFO1234ze | HFC134a |
|---|---|---|---|
| (° F.) | K factor (Btu · in./ft² · h · ° F.) | | |
| 17.6 | 0.1222 | 0.1337 | 0.1298 |
| 32.0 | 0.1250 | 0.1373 | 0.1343 |
| 50.0 | 0.1302 | 0.1430 | 0.1419 |
| 75.2 | 0.1416 | 0.1542 | 0.1535 |
| 104.0 | 0.1549 | 0.1677 | 0.1670 |

Table 5 shows that at the same blowing level, foams blown with trans HCFO-1233zd exhibits a lower density and higher blowing efficiency than foams blown with HFO1234ze or HFC134a.

TABLE 5
Comparison of free-rise density of HFC134a
and HCFO-1233zd (trans) foam

| Blowing agent | Free Rise Density (pcf) |
|---|---|
| HCFO-1233zd (trans) | 1.71 |
| HFO1234ze | 1.78 |
| HFC134a | 2.01 |

### Example 3

Testing following the procedure outlined above was undertaken with blowing agents comprising: a control with 99 wt % or more the trans isomer of HCFO-1233zd; a 96.5/3.5 wt % blend of trans and cis isomers of HCFO-1233zd; a 70/30 wt % blend of trans and cis isomers of HCFO-1233zd; and a 100 wt % cis isomer of HCFO-1233zd materials. The k-factor measurements (ASTM C518) on the resulting foams were conducted at between 18 and 104° F. Initial k-factors are taken within 24 hours after removing the foam skin with a band saw. K-factors were also measured at one week and one month. Lower k-factors indicate better insulation values. The foam formulations tested are summarized in Table 6 and each contained: Voranol 490 a polyol from Dow Chemical Company; Jeffol R-425-X a polyol from Huntsman; Stepan 2352 a polyol from Stepan; Poylcat-5 (PC-5) and Polycat-8 (PC-8) catalyst from Air Products; Tegostab B 8465 a surfactant from Evonik-Degussa; tris(1-chloro-2-propyl) phosphate (TCPP) a flame retardant.

TABLE 6

| | Control | 96.5/3.5 | 70/30 | 0/100 |
|---|---|---|---|---|
| B side | | | | |
| Voranol 490 | 18.09 | 18.09 | 18.09 | 18.09 |
| Jeffol R-425-X | 10.85 | 10.85 | 10.85 | 10.85 |
| Stepan 2352 | 7.24 | 7.24 | 7.24 | 7.24 |
| PMDETA (PC-5) | 0.07 | 0.07 | 0.07 | 0.07 |
| DMCHA (PC-8) | 0.37 | 0.37 | 0.37 | 0.37 |
| Tegostab B 8465 | 0.71 | 0.71 | 0.71 | 0.71 |
| TCPP | 2.36 | 2.36 | 2.36 | 2.36 |
| Added water | 0.64 | 0.64 | 0.64 | 0.64 |
| E1233zd | 7.00 | 6.75 | 4.90 | — |
| Z1233zd | — | 0.25 | 2.10 | 7.00 |
| Total B Side: | 47.34 | 47.34 | 47.34 | 47.34 |
| A Side | | | | |
| Index | 115 | 115 | 115 | 115 |
| Isocyanate | 52.7 | 52.7 | 52.7 | 52.7 |
| A/B | 1.11 | 1.11 | 1.11 | 1.11 |
| B/A | 0.90 | 0.90 | 0.90 | 0.90 |
| Total Blowing | 20.0 | 20.0 | 20.0 | 20.0 |

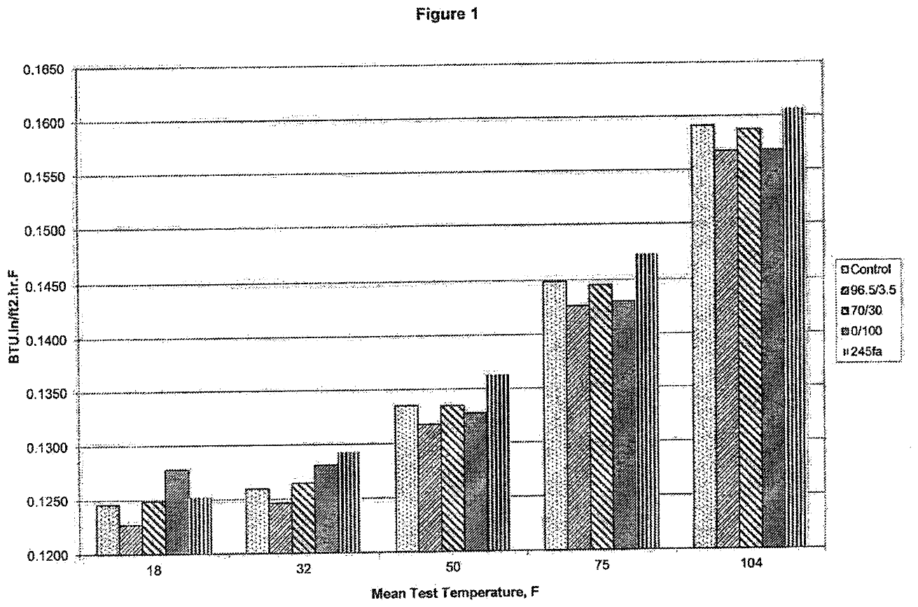

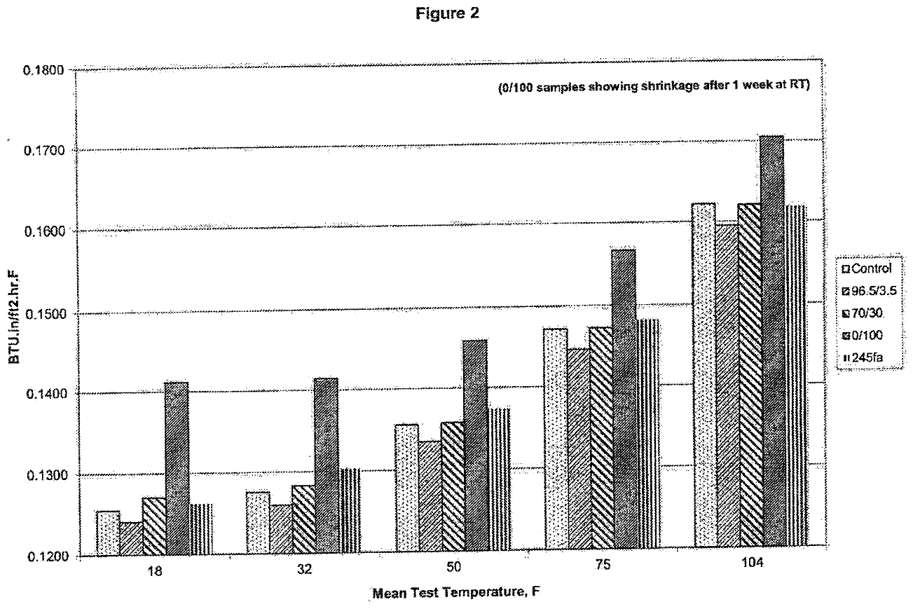

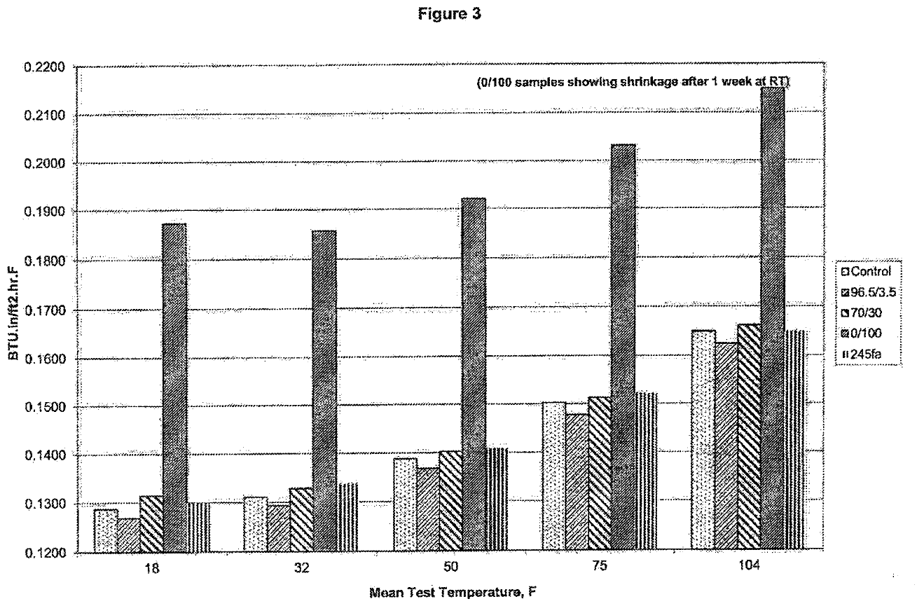

The results are summarized in FIGS. 1, 2 and 3. FIG. 1 shows that initially, at lower temperatures, the cis materials exhibits a slightly higher k-factor, but the difference is negligible at higher temperatures between foams made using the control, over 99 wt % trans HCFO-1233zd composition, a 70/30 wt % trans/cis HCFO-1233zd mixture, a 96.5/3.5 wt % trans/cis HCFO-1233zd mixture and a 100 wt % cis HCFO-1233zd materials. However, FIGS. 2 and 3 show that after one week and one month of aging under ambient condition, foams made with the cis HCFO-1233zd material exhibited significant shrinkage that impacted k-factors. The foams made with 70 wt % or more trans HCFO-1233zd compositions exhibited negligible shrinkage and much lower k-factors. The impact on k-factor over time is believed to be, in part, due to dimensional stability changes, i.e. foam shrinkage, It is surprising and unexpected that the trans HCFO-1233zd and cis HCFO-1233zd isomers produced foam that exhibit such significantly different dimensional stability and thus k-factor over time.

### Example 4

Toxological testing was undertaken as part of the evaluation of HCFO-1233zd as a blowing agent. Ames testing was performed on a blend of trans- and cis-HCFO-1233zd and purified trans-HCFO-1233zd. The Ames test is a study designed to determine if a material can interact with DNA and cause point mutations, i.e. to determine if a material is mutagenic. Many carcinogenic materials are also mutagenic and this assay is often used as a quick screen for potential to cause an adverse effect on genetic material. It utilizes several strains of bacteria (Salmonella typhimurium and E. coli) and is often routinely included when developing the toxicology profile of a substance. If a substance substantially increases the mutation rate in the bacterial tester strains, the study result is defined as positive and the test substance is considered to be mutagenic.

The purpose of the study was to evaluate the mutagenic potential of the test article vapor by measuring it ability to induce reverse mutations at selected loci of several stains of Salmonella typhimurium and at the tryptophan locus of Escherichia coli strains WP2 uvrA in the presence and absence of Aroclor-induced rat liver S9. The test system was exposed to the test article via desiccator methodology. For each replicate plating, the mean and standard deviation of the number of revertants per plate were calculated and reported. Negative and positive controls were also run.

For the test article to be evaluated positive, it must cause a dose-related increase in the mean revertants per plate of at least one tester strain over a minimum of two increasing concentrations of test article. Data for tester strains TA1535 and TA1537 were judged positive if the increase in mean revertants at the peak of the dose response is equal to or judged greater than 3.0-times the mean vehicle control value. Data sets for tester strains TA98, TA100 and WP2 uvrA were judged positive if the increase in mean revertants at the peak of the dose response is equal to or greater than 2.0-times the mean vehicle control value.

A mixture of cis- and trans-isomers of 1-chloro-3,3,3-trifluoropropene (CAS #2730-43-0, HFCO-1233zd) consisting of 71.2 wt % trans- and 28.5 wt % cis-1-chloro-3,3,3-trifluoropropene was subjected to Ames assay as described above. Table 7 summarizes the composition of the materials tested by the Ames test.

TABLE 7

Weight % composition

| Name | Mixture | Pure |
|---|---|---|
| trans-1-chloro-3,3,3-trifluoropropene | 71.2 | 96.5 |
| cis-1-chloro-3,3,3-trifluoropropene | 28.5 | 3.2 |
| others | 0.3 | 0.3 |

In the mutagenicity assay of the cis-/trans-mixture, a positive response was observed at ≥3.0 mL per desiccator with tester strain TA1535 in the presence of S9 activation as indicated by the increase in revertants per plate. No precipitate was observed but toxicity was observed (initial mutagenicity assay only) at ≥3.0 mL per desiccator with tester strain WP2 uvrA in the presence of S9 activation only as indicated by the drop to zero revertants per plate. This substance elicited a positive response in the Ames test and was reported to be mutagenic under the conditions of this assay.

A purified material, consisting of 96.5 weight % the trans-isomer of 1-chloro-3,3,3-trifluoropropene was subjected to testing in the Ames assay as described above. The purification of the material required multiple distillation steps. The results of the reverse mutation assay using vapor-phase exposure indicated that, under the conditions of the study, the material did not cause a positive mutagenic response with any of the tester strains in either the presence of or absence of Aroclor-induced rat liver S9. No toxicity was observed.

This testing indicated that the cis-isomer is the active mutagenic agent in this mixture. Removing most of the cis-isomer rendered the material non-mutagenic and thus, having a more favorable toxicity profile. The trans-isomer of 1-chloro-3,3,3-trifluoropropene was considered to be less toxic. The “other” materials 245fa; 244fa; and HFO-1234ze present in the materials tested were evaluated in foam studies and they did not significantly negatively impact foam dimensional stability.

Although the invention is illustrated and described herein with reference to specific embodiments, it is not intended that the appended claims be limited to the details shown. Rather, it is expected that various modifications may be made in these details by those skilled in the art, which modifications may still be within the spirit and scope of the claimed subject matter and it is intended that these claims be construed accordingly.

### Example 5

Testing was undertaken to measure the evolution over time of the K-factor in foams made with various blowing agents.

The formulation of the foams was the following (in weight %):

TABLE 8

| Formulation | % (Weight) |
|---|---|
| Jeffol R-425-X | 10.85 |
| Stepanpol PS-2352 | 7.22 |
| Voranol 490 | 18.09 |
| Tris(chloropropyl) phosphate | 2.36 |
| Water | 0.64 |
| Tegostab B8465 | 0.71 |
| Polycat 5 | 0.07 |
| Polycat 8 | 0.37 |
| Blowing Agent | 7.00 |
| Rubinate M | 52.7 |

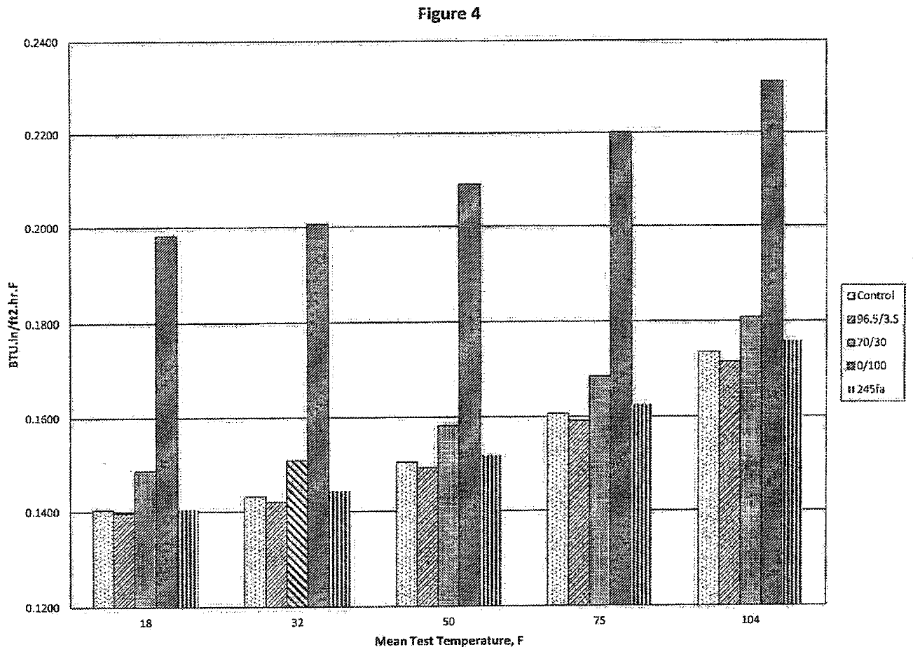

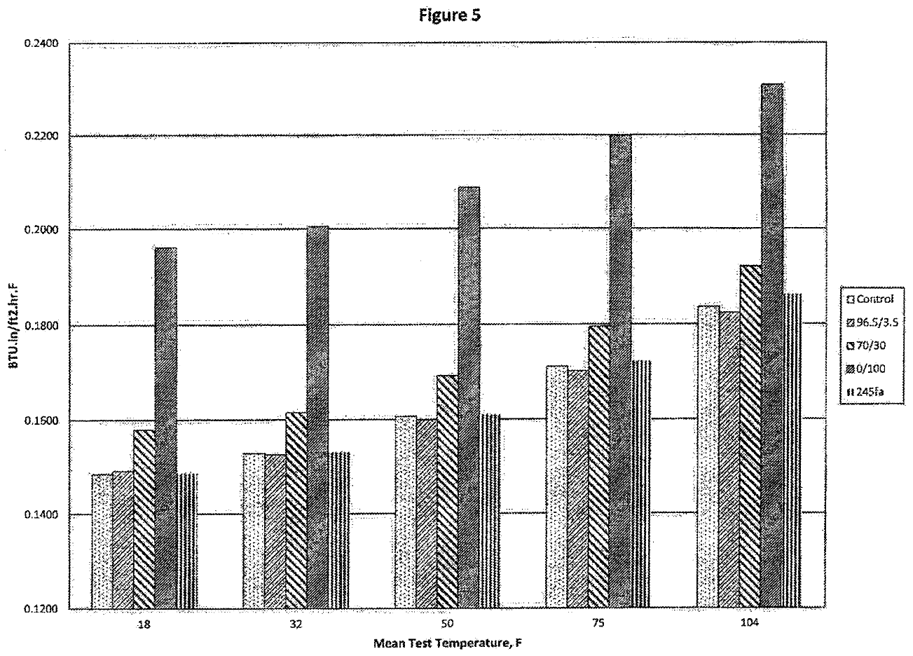

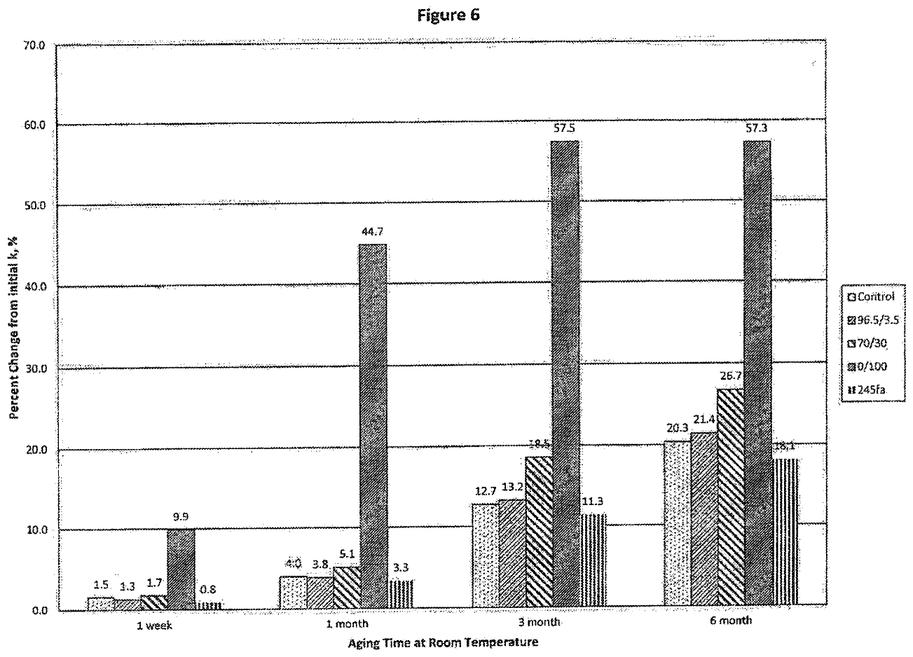

The blowing agents tested were: 245fa (1,1,1,3,3-pentafluoropropane a commercially available foam blowing agent); trans-HCFO-1233zd (designated as “control” in FIGS. 4-9); cis-HCFO-1233zd (designated as “0/100” in FIGS. 4-9); a 96.5%/3.5% mixture of trans/cis-HCFO-1233zd (designated as “96.5/3.5” in FIGS. 4-9); and a 70%/30% mixture of trans/cis-HCFO-1233zd (designated as “70/30” in FIGS. 4-9). The cis and trans isomers of HCFO-1233zd used in these experiments were 99.9% pure. FIG. 6 shows that the change in k-factor for foam made with HFC-245fa, after aging for six months, was 18.1% while the change in k-factor for foams made with blends of trans/cis HCFO-1233zd and trans HFCO-1233zd, after aging for six months, were 26.7, 21.4 and 20.3 percent. Thus foams made with trans/cis blends and trans HCFO-1233zd achieved a change in k-factor of about 10% or less relative to HFC245fa.

Physical test samples were made in 6″×6″×6″ open box pours by a conventional hand-mix technique. Due to the nature of the free rise foams, the samples were cut such that the foam rise was parallel to the test face in order to minimize the effect of any defects running completely through the sample thickness. Also, since the k-factor samples were undersized, 5″×5″×1″, each test piece was surrounded by like material in order to test a full 12″×12″×1″ sample.

The k-factor measurements (according to ASTM C518) on the resulting foams were conducted at various temperatures between 17.6 and 104° F. (−8° C. to 40° C.). The test method covers the measurement of steady state thermal transmission through flat slab specimens using a heat flow meter apparatus.

Initial k-factors were taken within 24 hours after removing foam skin with a band saw. Other measurements were made 1 week, 1 month, 3 months and 6 months afterwards. The samples were stored at room temperature.

Lower k-factors indicate better insulation values.

FIG. 1 shows the initial K-factors, measured in Btu·in./ft²·h·° F. No significant difference was observed in initial K-factors between the foams made with the various blowing agents. The tests on the aged samples (FIGS. 2-5) show that K-factors for foams made with 100% cis-HCFO-1233zd increased significantly over time in comparison with foams made with blowing agents containing 70%, 96.5% or 100% trans-HCFO-1233zd, as well as the 245fa blowing agent. FIG. 6 shows the percentages of change in k-factor over time at 50° F. (10° C.).

### Example 6: Preparation of Handmix Foam

The control system was a generic normal pentane/isopentane (50/50 wt %) PIR boardstock system. The normal pentane/isopentane blend was replaced with 10, 20, 40, 60, 80, and finally 100% (by weight) of HCFO-1233zd. Handmix foams were evaluated for reactivity, free rise density, dimensional stability, compressive strength, thermal conductivity, and closed cell content. Several experiments were run to optimize the control system. The formulation shown in Table 2 below, was selected as the control based upon a number of runs in which foam produced with various catalyst, polyester polyol and surfactant combinations were evaluated for reactivity, foam quality, k-factor, dimensional stability, compressive strength, and closed cell content.

In order to reduce frothing and minimize loss of blowing agent in an open cup pour, the chemicals were cooled to 60° F.; see Table 9 and 10 for formulation details. To keep the catalyst, surfactant, water, and blowing levels, as well as index, consistent across the experiment, it was necessary to vary the polyol levels slightly, as noted in the table below.

TABLE 9
PIR Boardstock System Formulations for Handmix Study

| | Normal/isopentane | HCFO-1233zd |
|---|---|---|
| Component | control | (40%) |
| Stepanpol ® PS 2352 | 29.35 | 28.81 |
| PMDETA | 0.06 | 0.06 |
| Dabco ® TMR 20 | 0.45 | 0.45 |
| Polycat ® 41 | 0.30 | 0.30 |
| Dabco ® Si3203 | 0.60 | 0.60 |
| TCPP | 3.01 | 3.01 |
| Water | 0.18 | 0.18 |
| Normal pentane | 3.31 | 2.42 |
| Isopentane | 3.31 | 2.42 |
| HCFO- 1233zd | — | 3.23 |
| Total B-side | 40.56 | 41.46 |
| Total pMDI | 59.44 | 58.54 |
| (Rubinate ® 1850) | | |
| Index on ROH | 280 | 280 |
| Total blowing | 22.85 | 22.85 |
| (ml gas/g foam) | | |
| Physical blowing to | 90/10 | 90/10 |
| CO₂ blowing (%) | | |

TABLE 10
PIR Boardstock System Formulations for Handmix Study

| | Normal/ | HCFO- | HCFO- | HCFO- | HCFO- | HCFO- | HCFO- |
|---|---|---|---|---|---|---|---|
| | isopentane | 1233zd | 1233zd | 1233zd | 1233zd | 1233zd | 1233zd |
| Components | control | (10%) | (20%) | (40%) | (60%) | (80%) | (100%) |
| Stepanpol ® | 29.92 | 29.80 | 29.68 | 29.37 | 28.99 | 28.51 | 27.88 |
| PS 2352 | | | | | | | |
| PMDETA | 0.06 | 0.06 | 0.06 | 0.06 | 0.06 | 0.06 | 0.06 |
| Dabco ® | 0.45 | 0.45 | 0.45 | 0.45 | 0.45 | 0.45 | 0.45 |
| TMR 20 | | | | | | | |
| Polycat ® 41 | 0.30 | 0.30 | 0.30 | 0.30 | 0.30 | 0.30 | 0.30 |
| Dabco ® Si | 0.60 | 0.60 | 0.60 | 0.60 | 0.60 | 0.60 | 0.60 |
| 3203 | | | | | | | |
| TCPP | 3.01 | 3.01 | 3.01 | 3.01 | 3.01 | 3.01 | 3.01 |
| Water | 0.18 | 0.18 | 0.18 | 0.18 | 0.18 | 0.18 | 0.18 |
| Normal | 3.31 | 3.11 | 2.91 | 2.42 | 1.81 | 1.03 | — |
| pentane | | | | | | | |
| Isopentane | 3.31 | 3.11 | 2.91 | 2.42 | 1.81 | 1.03 | — |
| HCFO- | — | 0.69 | 1.45 | 3.22 | 5.43 | 8.24 | 11.98 |
| 1233zd | | | | | | | |
| Total B-side | 41.12 | 41.32 | 41.53 | 42.02 | 42.62 | 43.40 | 44.44 |
| Total pMDI | 58.88 | 58.68 | 58.47 | 57.98 | 57.38 | 56.60 | 55.56 |
| (Mondur ® | | | | | | | |
| 489) | | | | | | | |
| Index on | 280 | 280 | 280 | 280 | 280 | 280 | 280 |
| ROH | | | | | | | |
| Total | 22.85 | 22.85 | 22.85 | 22.85 | 22.85 | 22.85 | 22.85 |
| blowing | | | | | | | |
| (ml gas/g | | | | | | | |
| foam) | | | | | | | |
| Physical | 90/10 | 90/10 | 90/10 | 90/10 | 90/10 | 90/10 | 90/10 |
| blowing to | | | | | | | |
| CO₂ blowing | | | | | | | |
| (%) | | | | | | | |

Table 11 shows the reaction times and free rise density (FRD) of the seven foam systems. Catalysts, surfactant, and water levels were kept constant across the various blends, which was shown in the similar reaction profiles and free rise density. There appeared to be a very slight increase in density as the amount of HCFO-1233zd increased, but mostly for the highest levels of 80 to 100%. This slight increase in density of less than 3%, could be attributed either to more loss of the blowing agent during the handmix because of the lower boiling point of HCFO-1233zd compared to the pentane blend or possibly due to surfactant choice.

All systems showed similar reactivity. Free rise density was also very consistent across the seven formulations; averaging 29.0±0.3 kg/m³ (1.81±0.02 pcf).

TABLE 11
Hand Mix Reaction Times and Free Rise Densities

| | Normal/ | HCFO- | HCFO- | HCFO- | HCFO- | HCFO- | HCFO- |
|---|---|---|---|---|---|---|---|
| Reactivity | isopentane | 1233zd | 1233zd | 1233zd | 1233zd | 1233zd | 1233zd |
| Details | control | (10%) | (20%) | (40%) | (60%) | (80%) | (100%) |
| A/B temp. | 15.6/15.6 (60/60) | | | | | | |
| ° C. (° F.) | | | | | | | |
| Mix time, sec | 5 | | | | | | |
| Reactivity and | 10 | 10 | 10 | 10 | 10 | 10 | 11 |
| density | | | | | | | |
| Cream time, sec | 35 | 35 | 35 | 34 | 33 | 33 | 31 |
| Gel time, sec | 54 | 57 | 56 | 54 | 54 | 57 | 53 |
| Tack-free time, sec | 69 | 70 | 66 | 70 | 65 | 69 | 64 |
| Rise time, sec | 28.5 | 29.0 | 29.0 | 28.9 | 29.0 | 29.2 | 29.3 |
| Free rise density, | (1.78) | (1.81) | (1.81) | (1.80) | (1.81) | (1.82) | (1.83) |
| kg/m³ (pcf) | | | | | | | |

### Foam Properties

Table 12, shows the test results for thermal conductivity, both initial and aged. The thermal conductivity improved significantly with increasing amounts of HCFO-1233zd in the blowing agent package. The foam samples were tested at three mean temperatures, 0, 10, and 24° C. (32, 50, 75° F.), to fully assess the overall performance profile of the blowing agent package.

The addition of HCFO-1233zd to the blowing agent package provided improvement to the thermal performance of the foam in two major ways. First the overall insulation value showed improvement over the entire test temperature range compared to the all pentane blown control. On average, each increase in HCFO-1233zd showed a better thermal conductivity over the previous lower loading; from a low of 2.6% better, versus the control, for the 10% loading to a high of over 20% better for the all HCFO-1233zd. Additionally, this difference was fairly consistent over 4 months of aging, especially for blends ≤60% HCFO-1233zd loading. The two higher blends, 80 and 100% HCFO-1233zd, did see a slight narrowing of the improvement over the control from 15 down to 13% for the 80% loading and from 21 down to 15% for the all HCFO-1233zd blown foam; indicating that foams with the highest loadings of HCFO-1233zd may be aging more rapidly than the lower loadings and the control.

The second major improvement to insulation value found when replacing some of the pentane blend with HCFO-1233zd was an overall enhancement in the thermal insulation value over the entire test temperature range, especially at the lower temperatures of 0° C. (32° F.) and 10° C. (50° F.). For the control and blends with 10 and 20% HCFO-1233zd, the thermal conductivity at 0° C. (32° F.) was actually higher than at the 10° C. (50° F.) test point. The thermal conductivity of the blends with 40% and higher, actually improves at the lower test temperatures.

TABLE 12
Hand Mix Foam Properties—Initial and Aged*

| Thermal | | | | | | | |
|---|---|---|---|---|---|---|---|
| conductivity, | Normal/ | HCFO- | HCFO- | HCFO- | HCFO- | HCFO- | HCFO- |
| mW/K · m³ | isopentane | 1233zd | 1233zd | 1233zd | 1233zd | 1233zd | 1233zd |
| (Btu · in/hr · ft² · ° F.) | control | (10%) | (20%) | (40%) | (60%) | (80%) | (100%) |
| | Initial | | | | | | |
| 0° C. (32° F.) | 22.2 | 21.2 | 20.6 | 19.3 | 18.2 | 17.2 | 16.2 |
| mean test temp | (0.1540) | (0.1473) | (0.1425) | (0.1338) | (0.1261) | 0.1193) | (0.1126) |
| 10° C. (50° F.) | 21.1 | 20.6 | 20.2 | 19.5 | 18.7 | 18.0 | 16.9 |
| mean test temp | (0.1462) | (0.1426) | (0.1398) | (0.1351) | (0.1299) | (0.1245) | (0.1175) |
| 24° C. (75° F.) | 21.6 | 21.4 | 21.2 | 20.8 | 20.2 | 19.4 | 18.3 |
| mean test temp | (0.1500) | (0.1485) | (0.1471) | (0.1446) | (0.1404) | (0.1347) | (0.1271) |
| | 1 month aged | | | | | | |
| 0° C. (32° F.) | 22.8 | 21.9 | 21.3 | 20.2 | 19.1 | 18.1 | 17.2 |
| mean test temp | (0.1580) | (0.1519) | (0.1475) | (0.1398) | (0.1324) | (0.1254) | (0.1196) |
| 10° C. (50° F.) | 21.8 | 21.3 | 20.9 | 20.3 | 19.6 | 18.8 | 18.0 |
| mean test temp | (0.1511) | (0.1477) | (0.1541) | (0.1411) | (0.1362) | (0.1306) | (0.1246) |
| 24° C. (75° F.) | 22.4 | 22.2 | 22.0 | 21.7 | 21.2 | 20.3 | 19.3 |
| mean test temp | (0.1555) | (0.1539) | (0.1526) | (0.1507) | (0.1468) | (0.1408) | (0.1339) |
| | 2 month aged | | | | | | |
| 0° C. (32° F.) | 23.7 | 22.8 | 22.1 | 20.9 | 19.8 | 18.8 | 18.2 |
| mean test temp | (0.1645) | (0.1582) | (0.1534) | (0.1451) | (0.1373) | (0.1302) | (0.1260) |
| 10° C. (50° F.) | 22.6 | 22.0 | 21.6 | 21.0 | 20.3 | 19.5 | 18.9 |
| mean test temp | (0.1564) | (0.1528) | (0.1499) | (0.1456) | (0.1406) | (0.1354) | (0.1311) |
| 24° C. (75° F.) | 23.2 | 22.9 | 22.7 | 22.4 | 21.9 | 21.0 | 20.3 |
| mean test temp | (0.1607) | (0.1591) | (0.1573) | (0.1553) | (0.1516) | (0.1459) | (0.1408) |
| | 4 month aged | | | | | | |
| 0° C. (32° F.) | 24.6 | 23.7 | 23.0 | 21.8 | 20.7 | 19.7 | 19.1 |
| mean test temp | (0.1705) | (0.1640) | (0.1597) | (0.1514) | (0.1435) | (0.1368) | (0.1328) |
| 10° C. (50° F.) | 23.2 | 22.7 | 22.3 | 21.7 | 21.1 | 20.6 | 20.0 |
| mean test temp | (0.1612) | (0.1575) | (0.1549) | (0.1508) | (0.1465) | (0.1425) | (0.1385) |
| 24° C. (75° F.) | 23.8 | 23.6 | 23.4 | 23.2 | 22.7 | 22.1 | 21.5 |
| mean test temp | (0.1648) | (0.1633) | (0.1623) | (0.1606) | (0.1577) | (0.1535) | (0.1488) |

*samples were 2.54 cm (1 inch) thick and aged at room temperature

Table 13 contains physical test data for compressive strength, dimension stability, and percent closed cell. Compressive strengths were run in both the parallel and perpendicular directions. In the parallel direction, all the blends gave foam with similar strengths. In the perpendicular direction, foams using from 10 to 40% HCFO-1233zd, also exhibited similar compressive strengths to the control. The compressive strengths showed a steady reduction from the 60% loading to the all HCFO-1233zd blown foam.

Dimensional stability was run in the three typical conditions for boardstock formulations: 70° C./97% RH (158° F.), 93° C./amb RH (200° F.), and −40° C./amb RH (−40° F.) for 14 days. Overall, the experimental blends gave comparable and acceptable percent volume changes to the control. Similar to dimensional stability, the percent closed cell for all the formulations showed little difference for the various blends. All were between 94 and 98%.

TABLE 13
Hand Mix Foam Properties—Comp. Str., DimStab, Closed Cell

| | Normal/ | HCFO- | HCFO- | HCFO- | HCFO- | HCFO- | HCFO- |
|---|---|---|---|---|---|---|---|
| | isopentane | 1233zd | 1233zd | 1233zd | 1233zd | 1233zd | 1233zd |
| | control | (10%) | (20%) | (40%) | (60%) | (80%) | (100%) |
| Compressive | | | | | | | |
| Str. kPa (psi) | | | | | | | |
| Parallel | 372.2 | 372.6 | 362.4 | 358.9 | 353.0 | 357.1 | 361.0 |
| | (54.0) | (54.0) | (52.6) | (52.1) | (51.2) | (51.8) | (52.4) |
| Perpendicular | 114.3 | 114.1 | 96.2 | 99.4 | 84.4 | 85.6 | 77.7 |
| | (16.6) | (16.6) | (14.0) | (14.4) | (12.3) | (12.4) | (11.3) |
| Dimensional Stability | | | | | | | |
| (% volume change*) | | | | | | | |
| 70° C./97% RH | 6.7 | 7.5 | 6.9 | 6.9 | 6.1 | 5.5 | 4.4 |
| (158° F.) | | | | | | | |
| 93° C./amb RH | 1.6 | 1.4 | 1.6 | 1.8 | 1.7 | 1.4 | 2.1 |
| (200° F.) | | | | | | | |
| −40° C./amb | −0.1 | −0.6 | −0.3 | −0.1 | −0.7 | −0.5 | −0.2 |
| RH (-40° F.) | | | | | | | |
| Closed Cell (%) | 97.9 | 97.4 | 96.5 | 96.2 | 94.9 | 96.0 | 93.7 |

*after 14 days in various conditions

### Example 6C: Handmix Foam Using: Pentane/HFC 134a Combinations and Pentane/HCFO-1233zd Combinations

PIR foams were made using pentane/HFC 134a combinations and pentane/HCFO-1233zd combinations according to the method as described in Example 6. The control system was a generic pentane PIR boardstock system. The pentane/HFC 134a combination included pentane with 10 and 20 percent (by weight) of HFC 134a. The handmix foams were evaluated. The properties were comparable to those in Example 6. Foams with higher than 20% by weight of HFC 134a in the pentane/HFC 134a blend couldn't be made due to low boiling point of HFC 134a. The foam samples were tested at four mean temperatures, 0°, 10°, 24°, and 40° C. (32°, 50°, 75°, 104° F.) over six months of time to fully assess the overall performance profile of the blowing agent package. Samples were tested initially (fresh sample), then at one, two, and six months. The degree of aging (% k-factor change, +: increase; −: decrease) was calculated: 100*k-factor_{(month=1,2, or 6)}/k-factorᵢₙᵢₜᵢₐₗ−100. Smaller increase in K-factor with aging is desired, indicating long term insulation is better.
Table 6C1 shows that adding HFC134a to the pentane significantly increased K-factor % increase after aging, even after only one month. Overall, long term insulation with the blends of pentane and HFC 134a were much worse than the pentane control. After aging for 6 months, K-factor % increase reached over 60% as compared to the pentane blend alone.

TABLE 6C1
Foam of Pentane and HFC 134a Blends: K-
factor at 104° F.: % Increase Over Time

| | | | | K-factor % increase |
|---|---|---|---|---|
| | | | | compared to pentane |
| % HFC134a | K-factor % increase | | | Control |
| in blend | Month 1 | Month 2 | Month 6 | Month 6 |
| 0 (Pentane | 3.279 | 8.197 | 14.754 | |
| Control) | | | | |
| 10 | 14.136 | 19.372 | 24.607 | 66.783 |
| 20 | 9.040 | 16.384 | 23.729 | 60.829 |

Testing was undertake of combinations of the blend of pentane and HCFO-1233zd comparable to the above testing of combinations of blends of pentane and HFC134a. Table 6C2 summarizes the results.

TABLE 6C2
Foam of Pentane and HCFO-1233zd Blends:
K-factor at 104° F.: % Increase Over Time

| | | | | K-factor % increase |
|---|---|---|---|---|
| % HCFO- | | | | compared to pentane |
| 1233zd | K-factor % increase | | | Control |
| in blend | Month 1 | Month 2 | Month 6 | Month 6 |
| 0 (Pentane | 3.312 | 7.110 | 11.942 | |
| Control) | | | | |
| 10 | 3.376 | 6.967 | 11.664 | −2.329 |
| 20 | 3.345 | 6.751 | 11.830 | −0.933 |
| 40 | 3.818 | 7.163 | 13.601 | 13.891 |
| 60 | 4.099 | 7.515 | 14.151 | 18.501 |
| 80 | 4.010 | 7.815 | 15.630 | 30.889 |
| 100 | 4.836 | 10.032 | 19.054 | 59.563 |

Table 6C2 shows similar aging results for the pentane control as for the testing of HFC 134a shown in Table 6C1. This confirms that the methods and results were consistent. Table 6C2 shows that the combinations of HCFO-1233zd and pentane, improved or slowed K-factor % increase upon aging. This is contrary to what was observed with combinations of HFC134a and pentane shown in Tale 6C1. In some combinations of HCFO-1233zd and petane, the long-term aging was almost equivalent to or even slightly better than the pentane control. The enhanced long term result for combinations of HCFO-1233zd and pentane is surprising and unexpected based upon the results observed for HFC134a and pentane, which was much worse that pentane alone.

### Example 7 Preparation of Machine Made Foam

Using a high-pressure foam machine, foams were made with a normal pentane/isopentane 50/50 wt % blend (control) and compared to a system blown with the pentane blend and HCFO-1233zd. Only one pentane/HCFO-1233zd system was run along with the control as confirmation of the results from the handmix experiment. A 40% HCFO-1233zd with the pentane blend was run; see Table 9 for formulation details. The polyol blends or ‘B’ sides were blended and mixed with an air mixer in an open pail. For blowing agents with boiling points at or below room temperature, the blend, minus blowing agent, was conditioned at 10° C. (50° F.) along with a container of the blowing agent prior to final mixing.

Machine parameters were kept constant throughout both runs. A water jacketed aluminum mold was used for the machine evaluations. A mold with internal dimensions of 35.6 cm×35.6 cm×7.6 cm thick (14″×14″×3″) was used to prepare k-factor, closed cell, cell size, dimensional stability, and fire test samples by injecting the pre-foam mixture through a pour hole located on the top of the mold in a horizontal orientation. All samples for physical property testing were demolded in 10 minutes. A minimum fill was determined for each system and then molds for foam properties were over-packed by about 5% above the minimum fill weight.

### Determination of Foam Properties

Measurement of all foam properties were conducted using standard ASTM procedures for rigid polyurethane foams. Foam density was measured according to ASTM D1622. Measurement of k-factors was done on 12.7 cm×12.7 cm×2.54 cm (5″×5″×1″) core foam samples using a LaserComp FOX 314 heat flow meter according to ASTM C518; as this was a screening experiment to prove the concept, it was decided to measure k-factors with this method instead of Long Term Thermal Resistance (LTTR) as per ASTM C1289. Closed cell contents were measured using a Gas Pycnometer according to ASTM D6226. Dimensional Stability was measured at −40° C./amb RH, 93° C./amb RH and 70° C./97% RH (−40, 199.4 and 158° F.) according to ASTM D2126. Compressive strength was measured according to ASTM D1621.

Table 14, summarizes the reaction times and core/bucket densities for the normal pentane/isopentane control system and the 40% HCFO-1233zd containing blend. The experimental system gave similar reaction profile and densities to the pentane blend control.

TABLE 14
Machine Reaction Tinies and Free Rise Densities

| | Normal/isopentane | HCFO-1233zd |
|---|---|---|
| Reactivity Details | control | (40%) |
| Cream time, sec | 5 | 3 |
| Gel time, sec | 20 | 19 |
| Tack-free time, sec | 37 | 28 |
| Core density, kg/m³ (pcf) | 27.7 (1.73) | 28.2 (1.76) |
| Bucket density, kg/m³ (pcf) | 31.7 (1.98) | 32.5 (2.03) |

### Process Properties

Tables 15, summarizes how the foam systems processed in the k-factor mold. This information includes minimum fill data, over pack and packed densities. Minimum fill weights and densities for the foam blown with 40% HCFO-1233zd were similar to the control system.

TABLE 15
Machine Foam Process Properties - k-factor mold details

| | Normal/isopentane | HCFO-1233zd |
|---|---|---|
| | control | (40%) |
| Fill weights and densities | 308 | 310 |
| Minimum fill wt, g | 32.1 (2.00) | 32.2 (2.01) |
| Minimum fill density, kg/m³ (pcf) | 5.6 | 5.0 |
| Percent over-pack | 325.2 | 325.5 |
| Panel weight at over-pack, g | 33.8 (2.11) | 33.8 (2.11) |
| Density at over-pack | | |

### Foam Properties

Overall, the machine run foam properties, shown below in Table 16, confirmed the findings of the handmix screening study. The thermal properties of foams made with HCFO-1233zd continued to outperform the normal pentane/isopentane control. Depending on the mean test temperature, for the 40% HCFO-1233zd blend foams k-factors improved as much as 12% at the lower test temperature to slightly over 2% for the higher temperature; results which match the performance of the 40% loading in the handmix study.

Compressive strengths were comparable to the control in both directions. As was the dimensional stability for all conditions. Percent closed cells were 94% or better for both foams.

TABLE 16
Machine Foam Properties

| | Normal/isopentane | HCFO-1233zd |
|---|---|---|
| | control | (40%) |
| Thermal conductivity | | |
| data, mW/K · m³ | | |
| (Btu · in/hr · ft² · ° F.) | | |
| @ 0° C. (32° F.) | 23.5 (0.1629) | 20.6 (0.1429) |
| @ 10° C. (50° F.) | 22.2 (0.1536) | 20.5 (0.1424) |
| @ 24° C. (75° F.) | 22.5 (0.1557) | 21.9 (0.1521) |
| Compressive Str. kPa (psi) | | |
| Parallel | 163.4 (23.7) | 140.0 (20.3) |
| Perpendicular | 184.8 (26.8) | 177.9 (25.8) |
| Dimensional stability | | |
| (% volume change*) | | |
| 70° C./97% RH (158° F.) | 4.4 | 5.1 |
| 93° C./amb RH (200° F.) | 5.6 | 5.5 |
| −40° C./amb RH (−40° F.) | −0.3 | −1.5 |
| Closed cell, % | 97.5 | 94.1 |

*after 14 days in various conditions

1. A polyisocyanurate foam composition comprising a polymer blowing agent composition comprising a combination of the hydrochlorofluoroolefin HCFO-1233zd and pentane wherein from about 10 to 60 wt % of said combination is the hydrochlorofluoroolefin HCFO-1233zd and from about 40 to 90 wt % is pentane and wherein more than about 70 wt % of said hydrochlorofluoroolefin HCFO-1233zd is the trans stereoisomer of hydrochlorofluoroolefin 1233zd.

2. The polyisocyanurate foam composition of claim 1 wherein said hydrochlorofluoroolefin HCFO-1233zd comprises about 90 wt % or more trans stereoisomer.

3. The polyisocyanurate foam composition of claim 1 wherein said hydrochlorofluoroolefin HCFO-1233zd comprises about 96.5 wt % or more trans stereoisomer.

4. The polyisocyanurate foam composition of claim 1, further comprising a hydrofluorocarbon.

5. The polyisocyanurate foam composition of claim 4 wherein said hydrofluorocarbon is selected from the group consisting of difluoromethane (HFC32); 1,1,1,2,2-pentafluoroethane (HFC125); 1,1,1-trifluoroethane (HFC143a); 1,1,2,2-tetrafluorothane (HFC134); 1,1,1,2-tetrafluoroethane (HFC134a); 1,1-difluoroethane (HFC152a); 1,1,1,2,3,3,3-heptafluoropropane (HFC227ea); 1,1,1,3,3-pentafluoropropane (HFC245fa); 1,1,1,3,3-pentafluorobutane (HFC365mfc) and 1,1,1,2,2,3,4,5,5,5-decafluoropentane (HFC4310mee).

6. The polyisocyanurate foam composition of claim 1, further comprising a hydrofluoroolefin.

7. The polyisocyanurate foam composition of claim 6 wherein said hydrofluoroolefin is selected from the group consisting of tetrafluoropropenes; trifluoropropenes; tetrafluorobutene isomers; pentafluorobutene isomers; hexafluorobutene isomers; heptafluorobutene isomers; heptafluoropentene isomers; octafluoropentene isomers; and nonafluoropentene isomers.

8. The polyisocyanurate foam composition of claim 1, further comprising an additive selected from the group consisting of C1 to C5 alcohols, C1 to C4 aldehydes, C1 to C4 ketones, C1 to C4 ethers, carbon dioxide, and C1 to C4 diethers.

9. The polyisocyanurate foam composition of claim 1, further comprising a hydrochlorofluoroolefin other than HCFO-1233zd.

10. The polyisocyanurate foam composition of claim 1 wherein from about 15 to 50 wt % of said combination is the hydrochlorofluoroolefin HCFO-1233zd and from about 50 to 85 wt % is pentane.

11. The polyisocyanurate foam composition of claim 1 wherein from about 20 to 60 wt % of said combination is the hydrochlorofluoroolefin HCFO-1233zd and from about 40 to 80 wt % is pentane.
